(19) United States
(12) Patent Application Publication
(10) Pub. No.: US 2026/0364773 A1
(43) Pub. Date: Nov. 19, 2026

(54) Collaborative Robot for Carrying Out a Service Task in an Elevator Shaft and Method for Operating the Collaborative Robot

(71) Applicant: INVENTIO AG, Hergiswil (CH)

(72) Inventor: Malcolm Mielle, Renens (CH)

(21) Appl. No.: 19/147,975

(22) PCT Filed: Feb. 26, 2024
(86) PCT No.: PCT/EP2024/054766

§ 371 Date: Jul. 14, 2025

(30) Foreign Application Priority Data
Mar. 7, 2023 (EP) 23160360.6

(51) Int. Cl. B25J 3/04; B25J 11/00; B66B 5/00

(52) U.S. Cl. CPC B25J 3/04; B25J 11/008; B66B 5/0087

(57) ABSTRACT

A collaborative robot for carrying out a service task in an elevator shaft is described. The robot includes a sensor arrangement for capturing at least one step of a task carried out by an operator of the robot in a safe environment outside the elevator shaft. At least one actuator arrangement carries out action(s) upon receiving a corresponding actuator signal. A control unit for robot operation is communicatively coupled to the sensor arrangement and actuator arrangement, and may receive at least one sensor signal from the sensor arrangement when the robot is arranged in the safe environment. The first sensor signal represents the step carried out by the operator, for determining at least one actuator signal, which is determined such that the actuator arrangement imitates the step upon receiving the actuator signal, and sends the actuator signal to the actuator arrangement when the robot is arranged in the elevator shaft.

The technology described herein generally relates to a collaborative robot for carrying out a service task in an elevator shaft and to a method for operating the collaborative robot.

Elevators serve for transporting passengers with an elevator car throughout a building. Typically, a multiplicity of passengers may be accommodated within an interior of the car and may then be transported for example from a first floor to a second floor in the building. In this description, the terms “first” and “second” are used in this context only to differentiate one floor from another and not for stating that e.g. the first floor is in fact the first floor of the building. Therefore, the first and second floor may be any two different floors of a building. During such travel, further passengers may enter or exit the car during intermediate stops at other floors. The car moves vertically from one floor to the other through an elevator shaft of the building.

Such an elevator has to be maintained by a maintenance worker on a regular basis, e.g. in accordance with a regular maintenance interval or because of a fault of the elevator. The maintenance worker may face different dangerous situations, which pose a threat to the worker, when maintaining the elevator. For example, the worker may have to access a top of the car or a pit of the elevator shaft in order to be able to maintain the elevator. Entering the top of the car or the pit may be dangerous, because of the depth of the elevator shaft, because of the movement of the car, because of the movement of another car in the elevator shaft, because of other moving objects in the elevator shaft, such as a counterweight of the elevator or the other elevator, and/or because of dangerous devices in the elevator shaft, e.g. devices being operated with high voltage and/or high voltage current.

Therefore, it is known to use a robot, in particular a collaborative robot (cobot), within the elevator shaft in order to replace the service or maintenance worker in the dangerous environment within the elevator shaft, at least for some of the tasks to be carried out by the service or maintenance worker. For example, EP 3 498 649 A1 describes an elevator inspection and maintenance system including a mechatronic body movable via remote or automatic operation, an inspection and maintenance head installed on the mechatronic body, where the inspection and maintenance head is fitted with a sensor or a manipulation tool to perform an inspection or a maintenance operation on at least one component of an elevator system remotely or automatically. The collaborative robot may be referred to as robot or cobot in the following. The service or maintenance worker may be referred to as worker in the following. Service or maintenance work may be referred to as service task, whereby a service task means at least one service task.

Further, it is known to program the robot by demonstrating the robot one or more steps of a task to be carried out by the robot in the elevator shaft, wherein each step may comprise one or more movements. The demonstration of the task may be carried out by an operator, in other words programmer, of the robot. A corresponding teaching method is described in “TEAM: a parameter-free algorithm to teach collaborative robots motions from user demonstrations.” by Lorenzo Panchetti, Jianhao Zheng, Mohamed Bouri, and Malcolm Mielle, arXiv: 2209.06940v1 [cs.RO] 14 Sep. 2022. Optionally, the teaching via demonstration by the operator may be complemented by programming the source code for operating the robot at least partly manually, e.g. also by the operator.

However, teaching tasks by demonstrations to a cobot in the field may be difficult, because the elevator shaft may be small and it may be difficult for the operator to move within the elevator shaft or to navigate the cobot in the elevator shaft. Further, teaching in the elevator shaft may be dangerous due to the depth of the elevator shaft, the movement of the moving objects, e.g. the car(s) and/or counterweight(s), and in some situations the necessity to move around the cobot to perform the teaching.

Accordingly, there is a need for a collaborative robot for carrying out a service task in an elevator shaft, which may be programmed in an easy and/or secure way, and/or which contributes to the safety of an operator programming and/or controlling the robot. Further, there is a need for a method for operating a collaborative robot for carrying out a service task in an elevator shaft, which may be carried out in an easy and/or secure way and/or which contributes to the safety of an operator programming and/or controlling the robot.

Such needs are met by the subject-matter of the independent claims. Advantageous embodiments are defined in the dependent claims as well as in the following specification and the associated figures.

According to a first aspect of the technology described herein, a collaborative robot for carrying out a service task in an elevator shaft is proposed. The collaborative robot comprises: a sensor arrangement configured for capturing at least one step of a task carried out by an operator of the robot in a safe environment outside the elevator shaft; at least one actuator arrangement configured for carrying out one or more actions upon receiving a corresponding actuator signal; and a control unit for operating the robot, wherein the control unit is communicatively coupled to the sensor arrangement and the actuator arrangement and wherein the control unit is configured for receiving at least a first sensor signal from the sensor arrangement when the robot is arranged in the safe environment, with the first sensor signal being representative for the step of the task carried out by the operator, for determining at least one actuator signal, wherein the actuator signal is determined such that the actuator arrangement imitates the step of the task upon receiving the actuator signal, and for sending the actuator signal to the actuator arrangement when the robot is arranged in the elevator shaft.

The sensor arrangement may comprise at least one sensor, e.g. a camera. The sensor may be configured for capturing at least one movement of the operator when the operator carries out the step of the task. The sensor arrangement may comprise two or more further sensors, e.g. one or more further cameras, a radar sensor, a microphone, a position sensor, an accelerometer, and/or a temperature sensor. The sensor arrangement may also comprise a tactile sensor, e.g. a button or touch pad, which may be activated by the operator or a service or maintenance worker. The sensor arrangement may also comprise or consist of sensors incorporated in the robot, especially in or near joints of the robots. These sensors are used during operation of the robot to determine or measure the positions of the joints. In this case no additional sensors are necessary.

According to the invention, the control unit is configured for receiving a second sensor signal from the sensor arrangement, the second sensor signal being representative for the robot being arranged in the elevator shaft; and for sending the actuator signal to the actuator arrangement after receiving the second sensor signal. The second sensor signal may be generated automatically by the same sensor as the first sensor signal. Alternatively, second sensor signal may be generated automatically by the accelerometer or by another camera of the sensor arrangement. Alternatively, the second sensor signal may be generated by the tactile sensor upon the tactile sensor being activated by the service or maintenance worker. For example, the robot may be arranged at a predetermined position in the elevator shaft and the operator or worker may activate the tactile sensor when the robot is arranged at the predetermined position. Alternatively, the second sensor signal may be remotely triggered via a remote-control unit coupled to the control unit, e.g. by the service or maintenance worker.

The actuator arrangement may comprise one or more actuators. The actuators may be mechanically coupled to an arm of the robot, wherein the arm may be regarded as part of the actuator arrangement. The arm may comprise one or more articulars coupled by correspondingly one or more joints and/or a grabbing toll, e.g. a gripper or claws, wherein the actuators may be mechanically coupled to the arm, in particular to the articulars and/or the grabbing tool, in order to move the arm, in particular to the articulars and/or the grabbing tool. One of the actuators may be configured for moving the robot from one position to another position, wherein this actuator may be an electric motor coupled to wheels of the robot. Each of the actions carried out by the actuator arrangement may comprise one or more movements of one or more of the actuators, in particular movements for imitating the step of the task and thereby for carrying out the task.

An operator may teach the robot by demonstration one or more steps of the task outside of the field, i.e. outside of the elevator shaft, in the safe environment, e.g. at his desk and/or in his office and/or in a laboratory, before the robot may be used in the field, i.e. in the elevator shaft. The tasks may be taught using a learning-from-demonstration framework, e.g. as described in the prior art mentioned above. Optionally, a custom-made app may be used to support the teaching of the robot. For example, in case of using the app, the operator may record a set of demonstrations, which may be used to teach the robot each motion of the step of the corresponding task. The task may comprise one or more steps. For example, when the robot may be used to perform a maintenance operation, e.g. cleaning a door of the elevator, the operator may teach the robot motions to open a dummy elevator door, to grab a cleaning tool, to clean the door, to drive back the robot back to its initial position, to close the dummy door, and to release the cleaning tool.

Each of the steps may comprise a series of more or less complex motions, in particular one or more movements of the corresponding step. For example, the step of grabbing the cleaning tool may comprise two movements, e.g. moving the arm of the robot to the cleaning tool and closing the grabbing tool of the robot arm to grab the cleaning tool. In contrast, the step of driving to the door may comprise one movement only, e.g. driving straight to the door. So, the sensor arrangement may be configured for capturing at least one of the movements, e.g. all movements which belong to a step. Further, the sensor arrangement may be configured for capturing all steps which belong to the task, wherein at least some of the steps may be captured in the safe environment and optionally some of the steps may be captured in the elevator shaft, whereas all steps carried out by the robot may be carried out in the elevator shaft. The safe environment may be a laboratory of a manufacturer of the robot or of the control unit.

The motions may be combined in task pipelines. For example, in order to create a task, the operator may use the app to create a task pipeline, wherein the task pipeline may be a logical flowchart of motions and corresponding actions. In the task pipeline, each motion may be represented by a name of the trained motion and a goal, e.g. a position, where and/or on which object the task has to be carried out by the robot. One of the steps may be represented by one or more task pipelines. The task pipelines may be used later in the field, for example for maintenance or installation. Furthermore, motions and task pipelines trained on a given robot at a given place may be saved in a “motion and pipeline” database. This database may be shared with all operators programming corresponding robots and may be used by the corresponding robots in the field without additional training.

Before bringing the robot in the elevator shaft, the operator may test the recorded task pipelines by setting fake goals and making sure that the robot performs the correct motions in order to carry out the corresponding steps and/or the corresponding task. Once one of the task pipelines is created and tested, the operator may arrange the robot in the field, i.e. the elevator shaft. Optionally, the operator may manually set one or more goals of the task pipeline in the elevator shaft. The task, in particular the task pipeline, the steps and the motions, may then be executed by the robot by carrying out each motion sequentially and thereby performing the task, in case with respect to the goal. In this scheme, the robot may be taught the motions before entering the shaft and, when being arranged in the shaft, only one or more given key points, i.e. the goals, to navigate to may be input to the robot, while the time to spend in the elevator shaft for the operator is short, thereby reducing the risks for the operator. So, the last job for the operator when programming the robot may be to set the goals, in particular position(s) of one or more goals in between the steps of a task, i.e. in the corresponding task pipeline, or between different tasks, i.e. between different task pipelines. For example, a special page in the app may allow the operator to manually move the robot for each goal defined in the pipeline to a specific position and to record the corresponding position. So, even the finalizing of the programming in the field, i.e. the elevator shaft, may be carried out by demonstration.

The collaborative robot being trained in the safe environment and being arranged in the elevator shaft to carry out one or more of the trained tasks may contribute to the safety of the worker, because the robot carries out the task in the dangerous environment and not the worker. In addition, the collaborative robot may contribute to the safety of the operator, because the operator does not have to spend much time for teaching the robot in the elevator shaft. Further, the collaborative robot may contribute to a high quality of the maintenance and/or service performance, because the task pipelines may be easily tested and, when necessary, adapted before putting the robot in field. Furthermore, the collaborative robot may enable a repeatability, because the task pipelines may be reused in different elevator shafts and may be easily adapted by simply changing the goals and keeping the same task, steps, and/or motions, e.g. in form of the actions of the robot. Not least the collaborative robot may enable a sharing of knowledge. In particular, motions and/or task pipelines corresponding to the steps may be trained by one operator under safe conditions and may be reused by all other operators later. Hence it is possible to create, in the safe environment, a database of motions and task pipelines that may be used by all robots in the field.

According to one embodiment, the task comprises at least two steps, the sensor arrangement is configured for capturing the steps of the task, and the actuator signal is determined such that the actuator arrangement imitates the steps of the task upon receiving the actuator signal. For example, the sensor arrangement may be configured for generating the first sensor signal which is representative for one of the steps and for generating another sensor signal which is representative for the other one of the steps. In this case, the control unit may be configured for receiving both sensor signals from the sensor arrangement and for determining the actuator signal and optionally one or more further actuator signals, wherein the actuator signal(s) may be determined such that the actuator arrangement imitates the steps of the task upon receiving the actuator signal. The steps may be subsumed in one task pipeline.

According to one embodiment, the sensor arrangement is configured for capturing a first step of the steps in the safe environment and for capturing a second step of the steps after being arranged in the elevator shaft. For example, the first step may comprise grabbing a tool, e.g. a cleaning tool or a screw driver, or how to use the tool, e.g. wiping or, respectively, rotating, and the second step may comprise to bring the tool in a position where the tool may be used, in other words to the corresponding goal. In this case, the control unit may be configured for receiving the first sensor signal representative for the first step from the sensor arrangement in the safe environment, for receiving another sensor signal representative for the second step from the sensor arrangement in the elevator shaft, and for determining the actuator signal and optionally one or more further actuator signals, wherein the actuator signal(s) may be determined such that the actuator arrangement imitates the steps of the task upon receiving the actuator signal.

According to one embodiment, the task can be carried out at at least two different goals, wherein at least a first goal of the goals is in the safe environment and wherein at least a second goal of the goals is in the elevator shaft, the sensor arrangement is configured for capturing the step of the task carried out by the operator in the safe environment at a first goal of the goals, and the actuator signal is determined such that the actuator arrangement imitates the step of the task at a second goal of the goals upon receiving the actuator signal in the elevator shaft. The first and second goals may refer to the same object. For example, the goals refer to a door. In particular, the first goal may be a dummy door in the safe environment and the second goal may be the door of the elevator shaft. In this case, the robot may be taught in the safe environment how to clean the dummy door and afterwards the robot may be used to clean the door of the elevator shaft. Alternatively, the first and second goals may refer to other, optionally similar objects. For example, the first goal may refer to the dummy door in the safe environment and the second goal may refer to an inner wall of the elevator shaft. In this case, the robot may be taught in the safe environment how to clean the dummy door and afterwards the robot may be used to clean the inner wall of the elevator shaft in the same way as he would clean the dummy door. So, the task may be “cleaning”, whereas the goal may be the elevator door or the inner wall of the elevator shaft. This concept may be transferred easily to other tasks, for example rotating a screwdriver, grabbing or releasing an object, pressing a button, and/or activating a lever, and/or to other goals, for example different screws, tools, buttons, and/or, respectively, levers.

The above features, advantages and/or effects of the collaborative robot may be transferred to a method for operating the collaborative robot explained in the following. In particular, the above features, advantages and/or effects of the embodiments of the technology described herein are described partly with respect to the above collaborative robot and partly with respect to the method for operating a collaborative robot, explained in the following. One skilled in the art will recognize that these features, advantages and/or effects may be suitably transferred from one embodiment to another and/or from the above first aspect to the second aspect. Therefore, with due regard to a concise description of the present invention, a repetitive explanation of these features, advantages and/or effects is omitted in the following and it is referred to the above explanations only. Further, features of different embodiments may be modified, adapted, combined and/or replaced, etc. in order to come to further embodiments of the technology described herein.

According to a second aspect of the technology described herein, the method for operating the collaborative robot for carrying out a service task in the elevator shaft is proposed. The robot comprising the at least one sensor arrangement configured for capturing the at least one step of the task carried out by the operator of the robot in the safe environment outside the elevator shaft, the at least one actuator arrangement configured for carrying the out one or more actions upon receiving the corresponding actuator signal; and the control unit for operating the robot, wherein the control unit is communicatively coupled with the sensor arrangement and the actuator arrangement. The method comprises the steps of: receiving the at least a first sensor signal from the sensor arrangement when the robot is arranged in the safe environment, with the first sensor signal being representative for the step of the task carried out by the operator; determining the at least one actuator signal, wherein the actuator signal is determined such that the actuator arrangement imitates the step of the task upon receiving the actuator signal; and sending the actuator signal to the actuator arrangement when the robot is arranged in the elevator shaft.

According to the invention, the method comprises receiving the second sensor signal from the sensor arrangement, the second sensor signal being representative for the robot being arranged in the elevator shaft; and sending the actuator signal to the actuator arrangement after receiving the second sensor signal.

In addition to the above-mentioned effects and advantages, this method may facilitates sharing of knowledge. For example, the task pipelines may be reused, wherein in some applications only the goals of the task pipeline may need to be changed between different runs of the robot in the field. For example, different start and/or goal positions may be used for different runs. This means that a task pipeline created on the robot in the safe environment may be transferred seamlessly to another robot in the field. In this context, the taught motions and corresponding task pipelines created for one robot may be saved in a cloud server which may be available to all other operators. For example, when an operator trains its robot to perform motion X and task pipeline Y, the motion X and the task pipeline Y may then be available to all other operators, reducing training times for all operators by avoiding redundant work.

The method may be carried out by the control unit of the robot. Alternatively, the method may be carried out by a computer outside of the robot, e.g. by the device on which the app is running. Alternatively, some steps of the method may be carried out by the control unit of the robot and some steps of the method may be carried out by the device on which the app is running.

According to one embodiment, the task comprises the at least two steps, the sensor arrangement is configured for capturing the steps of the task, and the actuator signal is determined such that the actuator arrangement imitates the steps of the task upon receiving the actuator signal.

According to one embodiment, the sensor arrangement is configured for capturing the first step of the steps in the safe environment and for capturing the second step of the steps after being arranged in the elevator shaft.

According to one embodiment, the task can be carried out at the at least two different goals, wherein the at least first goal of the goals is in the safe environment and wherein the at least second goal of the goals is in the elevator shaft, the sensor arrangement is configured for capturing the step of the task carried out by the operator in the safe environment at the first goal of the goals, and the actuator signal is determined such that the actuator arrangement imitates the step of the task at the second goal of the goals upon receiving the actuator signal in the elevator shaft.

According to one embodiment, the method comprises arranging the robot in the elevator shaft after receiving the first sensor signal in the safe environment and before sending the actuator signal to the actuator arrangement in the elevator shaft. The robot may be arranged in the elevator shaft by arranging the robot on top of the car of the elevator, under the bottom of the car, in the pit of the elevator shaft, or in a shaft head of the elevator shaft.

In the following, advantageous embodiments of the technology described herein will be described with reference to the enclosed drawings. However, neither the drawings nor the description shall be interpreted as limiting the technology described herein.

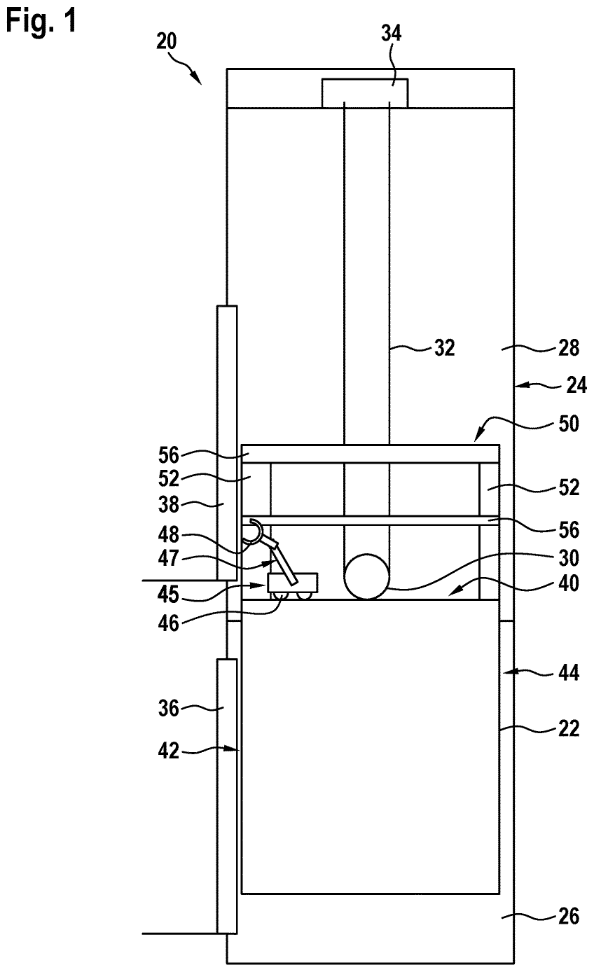

FIG. 1 shows a side view of an elevator shaft of an elevator, of a car of the elevator, and of a collaborative robot, according to an embodiment of the technology described herein.

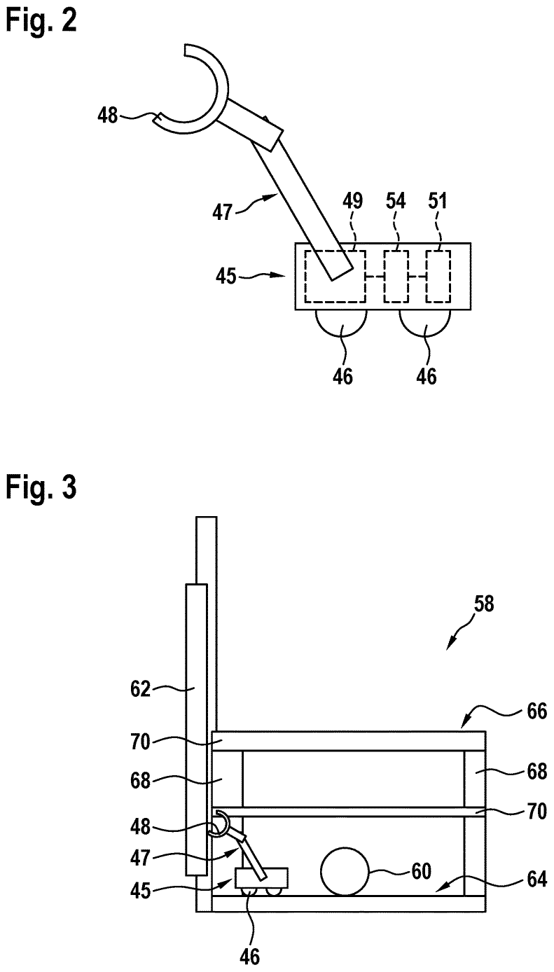

FIG. 2 shows a side view of the collaborative robot according to FIG. 1.

FIG. 3 shows a side view of the collaborative robot of FIGS. 1 and 2 in a safe environment, according to an embodiment of the technology described herein.

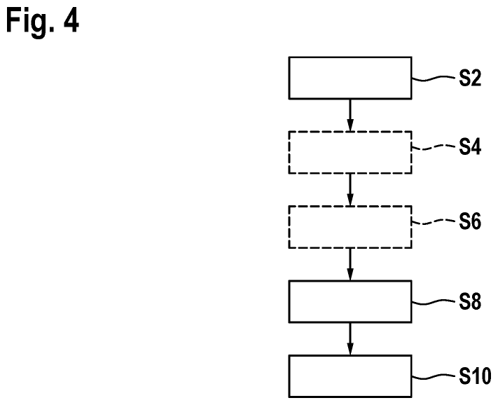

FIG. 4 shows a flowchart of a method for operating a collaborative robot, according to an embodiment of the technology described herein.

The figures are only schematic and not to scale. Same reference signs refer to same or similar features.

FIG. 1 shows a side view of an elevator shaft 24 of an elevator 20, of a car 22 of the elevator 20, and of a collaborative robot 45, according to an embodiment of the technology described herein. The elevator 20 comprises the car 22, the elevator shaft 24, a car holder 30, a cable 32, a motor 34, a first door 36 and a second door 38. The car 22 comprises a railing 50 on a top 40 of the car 22.

The elevator 20 may be arranged in a building having several floors. In particular, the building may have a first floor 26 and a second floor 28, wherein in this context the terms “first” and “second” are only used to differentiate one floor from another and may refer to any of the floors of the building. The elevator 20 may be arranged for transporting a load, e.g. one or more people and/or any another load, from one floor to the other, for example from the first floor 26 to the second floor 28 or vice versa.

The car 22 may be configured for accommodating the load, i.e. the one or more people and/or the other load. The load and/or the people may enter the car 22 through the first door 36, when the car 22 is in the first floor 26, or the second door 38, when the car 22 is in the second floor 28. The car 22 may comprise a maintenance flap (not shown) through which a service and/or maintenance worker, in short “worker”, may climb on the top 40 of the car 22. The car 22 may be held and may be vertically transported within the elevator shaft 24 by the car holder 30 and the cable 32. The cable 32 may be moved by the motor 34. The motor 34 may be controlled by a control unit (not shown) of the elevator 20. A front 42 of the car 22 may face the doors 36, 38 when the car 22 is arranged in the corresponding floor 24, 26, whereas a back 44 of the car 22 may face away from the doors 36, 38.

The railing 50 on the top 40 of the car 22 may be arranged for protecting the worker from falling off the top 40 of the car 22. The railing 50 may at least partly surround an inner region of the top 40 of the car 22. The railing 50 may comprise one or more handrails 56. The railing 50 may comprise one or more vertical posts 52, wherein the handrails 56 each may extend from one of the posts 52 to another one of the posts 52.

The collaborative robot 45, in short “robot”, may comprise wheels 46 for driving the robot 45 to one or more positions within the elevator shaft 24. The collaborative robot 45 may be arranged on the top 40 of the car 22, on an underside of the car 22, or within a pit of the elevator shaft 24 underneath the car 22, for example. The robot 45 may comprise an arm 47, wherein the arm 47 may comprise one or more articulars, e.g. two articulars, and/or a grabbing tool 48 which may be coupled to each other and/or to a rest of the robot 45 by correspondingly one or more joints (not shown).

FIG. 2 shows a side view of the collaborative robot according to FIG. 1. From FIG. 2 it may be seen that the robot 45 comprises an actuator arrangement 49 comprising one or more actuators. The actuators may for example comprise one electric motor each. The actuator arrangement 49 may be coupled to the arm 47 such that the arm 47 including the grabbing tool 48 may be moved by the actuators of the actuator arrangement 49. Further, the robot 45 comprises a sensor arrangement 51 comprising one or more sensors, e.g. one or more cameras, a radar sensor, a microphone, a position sensor, an accelerometer, a temperature sensor, and/or a tactile sensor, e.g. a button or touch pad.

The robot 45 further comprises a control unit 54 for operating the robot 45. The control unit 54 is communicatively coupled to the sensor arrangement 51 and the actuator arrangement 49. The control unit 54 is configured for receiving at least a first sensor signal from the sensor arrangement 51 when the robot is arranged in a safe environment 58 (see FIG. 3), with the first sensor signal being representative for a step of a task carried out by an operator of the robot 45, for determining at least one actuator signal, wherein the actuator signal is determined such that the actuator arrangement 49 imitates the step of the task upon receiving the actuator signal, and for sending the actuator signal to the actuator arrangement 49 when the robot 45 is arranged in the elevator shaft 24. A detailed functionality of the control unit 54, in particular a method for operating the robot 45, which may be carried out at least in part by the control unit 54, may be described with respect to FIG. 4.

FIG. 3 shows a side view of the collaborative robot of FIGS. 1 and 2 in the safe environment 58, according to an embodiment of the technology described herein. The safe environment 58 may be a desk and/or a office and/or a laboratory of an operator (not shown) of the robot 45. The operator teaches the robot 45 one or more movements for carrying out one or more steps of one or more tasks in the safe environment 58. The safe environment 58 may comprise one or more dummy objects in order to imitate the real situation within the elevator shaft 24. For example, the safe environment 58 may comprise a dummy car holder 60 which may correspond to the car holder 30, a dummy door 62 which may correspond to one of the doors 36, 38, a dummy top of the car 64 which may correspond to the top 40 of the car 22, a dummy railing 66 which may correspond to the railing 50, a dummy post 68 which may correspond to the post 52, and/or a dummy handrail 70 which may correspond to the handrail 56. Further, the safe environment 58 may comprise one or more dummy screws, dummy tools, dummy buttons, and/or dummy levers (not shown) which may be used to teach the robot 45 in the safe environment 58.

FIG. 4 shows a flowchart of a method for operating a collaborative robot, according to an embodiment of the technology described herein, e.g. the above robot 45. The method may be carried out by the control unit 54 of the robot 45. Alternatively, the method may be carried out by a computer outside of the robot 45, e.g. by the device on which the app is running, e.g. by a handheld and/or mobile device. Alternatively, some steps of the method may be carried out by the control unit 54 of the robot 45 and some steps of the method may be carried out by the device on which the app is running.

The method enables to program the robot 45 in the safe environment 58 by demonstration, e.g. as far as possible, and to put the robot 45 in the dangerous environment, i.e. the elevator shaft 24, afterwards, wherein no more than a few smaller adaptions of the programming may have to be adapted in the elevator shaft 24, e.g. adapting one or more goals on which the robot 45 may have to carry out a task, e.g. by demonstration.

In a step S2, at least a first sensor signal may be received from the sensor arrangement 51 when the robot 45 is arranged in the safe environment 58. The first sensor signal may be generated by at least one sensor of the sensor arrangement 51, e.g. by the camera, when the camera captures the task carried out by the operator in the safe environment 58. Therefore, the first sensor signal may be representative for the step of the task carried out by the operator. The task may comprise one or more steps. Each of the steps may comprise a series of more or less complex motions, in particular one or more movements of the corresponding step. The sensor arrangement 51 may be configured for capturing at least one of the movements, e.g. all movements which belong to a step. Further, the sensor arrangement 51 may be configured for capturing all steps which belong to the task and to encode the corresponding motions in the first sensor signal and/or one or mor further sensor signals.

After teaching the robot 45 the task, one or more steps of the task, or at least one or more motions of a step of the task, the robot 45 may be arranged in the elevator shaft 24, e.g. on the top 40 of the car 22, under the car 22, in the pit, or in the shaft head.

In an optional step S4, a second sensor signal may be received from the sensor arrangement 51. The second sensor signal may be representative for the robot 45 being arranged in the elevator shaft 24. For example, the control unit 54 of the robot 45 may be configured for automatically detecting the robot 45 being arranged in the elevator shaft 58 with the help of the sensor arrangement 51, e.g. with the camera and/or the accelerometer, e.g. by analyzing the corresponding sensor signal. Alternatively, the second sensor signal may be triggered by manually activating a tactile sensor of the robot 45, e.g. a button or a touch pad of the robot 45. For example, the operator may press the tactile sensor after arranging the robot 45 in the elevator shaft 24. Alternatively, the operator may trigger the second sensor signal remotely, e.g. via an app for controlling the robot 45.

In an optional step S6, one or more additional motions of one of the steps and/or one or more additional steps of one of the task may be taught to the robot 45 by demonstration in the elevator shaft 24. Alternatively or additionally, one or more goals on which the task(s) may have to be carried out may be shown to the robot 45 in the elevator shaft 24, in particular by demonstration through the operator. For example, the task may be carried out at at least two different goals, wherein the at least first goal of the goals is in the safe environment 58 and wherein the at least second goal of the goals is in the elevator shaft 24. The first and second goals may refer to the same object. Alternatively, the first and second goals may refer to different, optionally similar objects.

In a step S8, at least one actuator signal may be determined by the control unit 54 of the robot 45, wherein the actuator signal is determined such that the actuator arrangement 49 imitates the step of the task upon receiving the actuator signal, in particular at the corresponding goal in the elevator shaft 24.

In a step S10, the actuator signal may be sent to the actuator arrangement 49. The actuator arrangement 49 may carry out the task on the goal in the elevator shaft 24 upon receiving the actuator signal.

Finally, it should be noted that the term “comprising” does not exclude other elements or steps and the “a” or “an” does not exclude a plurality. Also elements described in association with different embodiments may be combined. Further, the invention is not restricted to the embodiments described above. It should also be noted that reference signs in the claims should not be construed as limiting the scope of the claims.

1. A collaborative robot for carrying out a service task in an elevator shaft, the robot comprising:
a sensor arrangement configured for capturing at least one step of a task carried out by an operator of the robot in a safe environment outside the elevator shaft;
at least one actuator arrangement configured for carrying out one or more actions upon receiving a corresponding actuator signal; and
a control unit for operating the robot, wherein the control unit is communicatively coupled to the sensor arrangement and the actuator arrangement and wherein the control unit is configured for:
receiving at least a first sensor signal from the sensor arrangement when the robot is arranged in the safe environment, with the first sensor signal being representative for the step of the task carried out by the operator,
determining at least one actuator signal, wherein the actuator signal is determined such that the actuator arrangement imitates the step of the task upon receiving the actuator signal,
sending the actuator signal to the actuator arrangement when the robot is arranged in the elevator shaft,
receiving a second sensor signal from the sensor arrangement, the second sensor signal being representative for the robot being arranged in the elevator shaft; and
sending the actuator signal to the actuator arrangement after receiving the second sensor signal.

2. The collaborative robot according to claim 1, wherein
the task comprises at least two steps,
the sensor arrangement is configured for capturing the steps of the task, and
the actuator signal is determined such that the actuator arrangement imitates the steps of the task upon receiving the actuator signal.

3. The collaborative robot according to claim 2, wherein the sensor arrangement is configured for capturing a first step of the steps in the safe environment and for capturing a second step of the steps after being arranged in the elevator shaft.

4. The collaborative robot according to claim 1, wherein
the task can be carried out at at least two different goals, wherein at least a first goal of the goals is in the safe environment and wherein at least a second goal of the goals is in the elevator shaft,
the sensor arrangement is configured for capturing the step of the task carried out by the operator in the safe environment at a first goal of the goals, and
the actuator signal is determined such that the actuator arrangement imitates the step of the task at a second goal of the goals upon receiving the actuator signal in the elevator shaft.

5. A method for operating a collaborative robot for carrying out a service task in an elevator shaft, the robot comprising at least one sensor arrangement configured for capturing at least one step of a task carried out by an operator of the robot in a safe environment outside the elevator shaft, at least one actuator arrangement configured for carrying out one or more actions upon receiving a corresponding actuator signal; and a control unit for operating the robot, wherein the control unit is communicatively coupled with the sensor arrangement and the actuator arrangement, the method comprising the steps of:
receiving at least a first sensor signal from the sensor arrangement when the robot is arranged in the safe environment, with the first sensor signal being representative for the step of the task carried out by the operator;
determining at least one actuator signal, wherein the actuator signal is determined such that the actuator arrangement imitates the step of the task upon receiving the actuator signal;
sending the actuator signal to the actuator arrangement when the robot is arranged in the elevator shaft
receiving a second sensor signal from the sensor arrangement, the second sensor signal being representative for the robot being arranged in the elevator shaft; and
sending the actuator signal to the actuator arrangement after receiving the second sensor signal.

6. The method according to claim 5, wherein the task comprises at least two steps,
the sensor arrangement is configured for capturing the steps of the task, and
the actuator signal is determined such that the actuator arrangement imitates the steps of the task upon receiving the actuator signal.

7. The method according to claim 6, wherein the sensor arrangement is configured for capturing a first step of the steps in the safe environment and for capturing a second step of the steps after being arranged in the elevator shaft.

8. The method according to claim 6, wherein
the task can be carried out at at least two different goals, wherein at least a first goal of the goals is in the safe environment and wherein at least a second goal of the goals is in the elevator shaft,
the sensor arrangement is configured for capturing the step of the task carried out by the operator in the safe environment at the first goal of the goals, and
the actuator signal is determined such that the actuator arrangement imitates the step of the task at the second goal of the goals upon receiving the actuator signal in the elevator shaft.

9. The method according to claim 5, further comprising:
arranging the robot in the elevator shaft after receiving the first sensor signal in the safe environment and before sending the actuator signal to the actuator arrangement in the elevator shaft.
